(19) United States
(12) Patent Application Publication
(10) Pub. No.: US 2014/0046370 A1
(43) Pub. Date: Feb. 13, 2014

(54) Orthodontic Comforter

(71) Applicant: Francois Fave-Lesage, Coussey (FR)

(72) Inventor: Francois Fave-Lesage, Coussey (FR)

(73) Assignee: ILTET, Vandoeuvre-les-Nancy (FR)

(21) Appl. No.: 14/007,163

(22) PCT Filed: Mar. 23, 2012
(86) PCT No.: PCT/FR12/50609

§ 371 Date: Sep. 24, 2013

(30) Foreign Application Priority Data
Mar. 25, 2011 (FR) 1152514

(51) Int. Cl. A61J 17/00

(52) U.S. Cl. CPC A61J 17/00
USPC 606/235; 606/236

(57) ABSTRACT

The invention relates to a comforter intended for children who have their primary or permanent dentition and whose central and lateral incisors have fully erupted, comprising in particular an intra-oral part (C), which has a hook-shaped lower incisor groove (2) comprising an inclined bite plane (6), the hollow of the groove and a retro-incisor return of reduced thickness. The intra-oral part can also have two opposite labial grooves (4) and (5), an upper incisor groove (1) opposite the groove (2) and separated therefrom by the inclined bite plane (6), and also a lingual bulb (3) centred on the upper part of the retro-incisor return of the groove (2), favouring the upper and forward position of the tongue. The invention further relates to a personalized comforter which, in the incisor groove (1) and/or in the incisor groove (2), has the impression of the incisors of the child for whom said personalized comforter is intended.

### FIELD OF THE INVENTION

The present invention concerns the field of childcare, and more particularly the field of comforters and dummies. The present invention concerns a comforter, and more particularly an orthodontic comforter intended for children aged over 1 year, whose lateral incisors have fully erupted, adapted to their mouth and dental anatomy and assisting normal respiration and deglutition.

### PRIOR ART

A great majority of parents use a comforter, which reassures and calms children, and has the advantage, compared with the thumb, of being able to be removed from the child.

Recourse to the thumb or traditional comforters has the main drawback of causing the maintenance of a space at the incisor level between the upper and lower dental arches when the teeth are clamped, this space being favourable to maintaining deglutition in the child.

However, it is estimated that, in more than 90% of patients, dento-maxillary deformities are related to a respiratory or deglutition dysfunction.

As from birth, the first function is respiration. The vital need to maintain this function requires complex neuromuscular synchronisation. “Optimum ventilation” is exclusively nasal, including during sleep and at rest. Respiration has an essential influence on dento-skeletal morphogenesis, particularly on the middle level of the face. The relationship between mouth respiration and cranio-facial deformities has been established by numerous authors.

In addition, nasal respiration filters the inspired air, regulates its temperature and humidity in order to improve the adsorption of oxygen through the lungs, and regulates the blood flow in the pulmonary vessels.

It is therefore essential to develop nasal rather than mouth respiration.

Deglutition is a stimulus to cranial-facial development in a child that occurs 1000 to 2500 times per day.

Infantile deglutition is characterised by the interposing of the tongue between the maxilla and the mandible, the tongue serving as a stabilising cushion between the maxillae, accompanied by a contraction of the labial and jugal muscles. Deglutition passes gradually from the infantile stage to the adult stage, which is the normal deglutition at the state of temporary teeth, around 3 to 4 years.

Normal, or adult, deglutition is characterised by maximum contact between the upper and lower teeth, a bearing of the tongue on the palatine face of the upper central incisors and on the retro-incisor papilla through the action of the masticatory muscles (masseter, pterygoid, and temporal).

Persistence of infantile deglutition after the age 3-4 years has two main medical consequences:
a favoured low lingual position that interferes with the growth of the mandible and the general posture of the child (compensation for the low position in front of the mandible);
interference with the arrangement of the upper and lower incisors and canines, causing in particular occlusion disorders, in addition to the aesthetic consequences.

Thus it has been shown that children who have used a comforter, whether conventional or so-called physiological, show a high predominance of alterations in the myofunctional structures, in comparison with children who have never used a comforter (Zardetto C, Rodrigues C and Stefani F, Pediatric Dentistry, 2002, 24, 552-560). The morphogenetic action of the lingual posture on the growth of the maxilla of the hard palate is accepted by all the authors. This explains the insufficiencies of maxillary development in children who have used a comforter since this use leads to the persistence of infantile deglutition associated with a low lingual position.

In 2010, a Swedish study estimated at 70% the proportion of children presenting orthodontic disorders with, in 50% of the cases, a wide anterior opening and in 19% of cases a unilateral cross bite (Dimberg L, Bondemark L, Soderfeldt B and Lennartsson B, Swed. Dent. J, 2010, 34, 35-42). It is known that the use of a feeding bottle causes disturbances to occlusion that the use of a comforter or sucking of the thumb will maintain, or even increase (Lindsten R, Larsson E and Ogaard B, Eur. J. Orthodontics 1996, 18, 205-209).

When infantile deglutition is maintained in particular following the use of a comforter, the incisors have a particular tendency to be projected forwards, leading to an incisor alveolar protrusion. In addition, a space may form between the upper and lower anterior teeth and leads to a wide incisor gap related to lingual dyspraxia. Warren J J et al. showed significant differences between the dental arches in children who have used a comforter for less than 12 months, 24 and 36 months (Warren J, Bishara S, Steinbock K, Yonezu T and Nowak A, J. Am. Dent. Assoc., 2001, 132, 1685-93). Studies have established a correlation between use of a comforter in children from two to five years and a significant increase in incisor overhang, greater than 4 mm, in the presence of a wide incisor gap and a posterior cross bite (Canadian Paediatric Society, Paediatr. Child Health, 2003, 8 (8), 515-519). These studies have shown that, the greater the number of months of use, the more the link with a wide gap and cross bite was probative. In a study in 1992, Adair et al. did not find any significant differences in dental deformations between users of traditional comforters and users of so-called physiological comforters (Adair S, Milano M and Dushku J, Pediatr, Dent., 1992, 14, 13-18). The term physiological therefore appears to be commercial rather than medical.

There therefore exists a need for a comforter not causing dento-maxillary distortions related on the one hand to mouth breathing and on the other hand to maintaining infantile deglutition, the latter in particular causing disorders in occlusion and problems in mandibular growth.

In the prior art, the majority of comforters or devices described consist of a rigid or semi-rigid exobuccal part and a flexible endobuccal part made from silicone or rubber, with various forms. Some devices have in particular been proposed in order better to distribute the suction forces and thus to avoid the appearance of occlusion disorders.

The patent WO 96/20687 presents a comforter which, according to the inventor, promotes movements of the tongue and mandible and contributes to the widening of the upper jaw through a lateral pressure on the alveolar crests. However, the volume of this comforter favours a low position of the tongue and prevents the performance of an adult deglutition movement with a retro-incisor bearing.

The patent WO 2008/014061 A2 also presents a comforter that limits the effects of lingual malfunction by distributing the pressure on the palate and the alveolar crest, but its intra-oral part forms a kind of shield, situated on the occlusion plane, which allows a child with teeth only a moderate lingual posture and prevents it from swallowing in an adult manner.

The patent FR 2595046 presents a comforter of large size, extending from canine to canine, the intra-oral thickness of which is relatively great, especially at the anterior level, which gives rise to a risk of causing a large incisor gap. This device appears to be more favourable to children without teeth or whose lacteal incisors are in the course of eruption, the mandible being in an end to end incisive position, whereas it should be slightly to the rear of the maxilla, and not allow the lower incisors to be overlapped by the upper ones, that is to say a class I ratio.

Other comforters or devices described in the prior art are also provided with a horizontal bite plane intended theoretically to provide optimum positioning of the jaws.

Thus the patent WO 2004/026219 presents a comforter to be used during the eruption of the lacteal teeth. According to some embodiments, the comforter of WO 2004/026219 has a horizontal bite plane, of varied forms. However, the comforter does not afford a specific placing of the teeth and appears specially to be intended for the period of eruption of the teeth, in particular in order to limit the pain thereof.

The patent U.S. Pat. No. 5,814,074 also presents a device with a horizontal bite plane. However, it does not make it possible to obtain an overlap of the lower incisors by the upper incisors, the plane separating them being horizontal rather than inclined upwards and to the rear. It also does not allow a high positioning of the tongue since the lingual stimulator is level with the occlusion plane rather than level with the incisor papilla. In addition, the round cross section of the device at the incisor level does not appear to be suited to dental anatomy. The large volume of the comforter brings the tongue into the distal and middle, or even low position. The device of the patent U.S. Pat. No. 5,814,074 appears once again to be more suited to children without teeth.

The patent WO 00/61065 also presents a device with a horizontal bite plane and comprises a teat situated at the same level as the bite plane, which makes it similar to the device of the patent U.S. Pat. No. 5,814,074. The teat of the device of the patent WO 00/61065 promotes a rear low position of the tongue and a piston movement thereof on the teat.

The patent FR 2 329 259 presents a device with a horizontal bite plane intended for the molars, and comprises a teat coming to be interposed between the tip of the tongue and the retro-incisor papilla. The large volume of this teat leads to a rear and low position of the tongue. In addition, the bite plane situated level with the posterior teeth does not make it possible to control the space between the upper and lower incisors.

The patent WO 98/02132 describes a comforter of which the intra-oral part has a concave surface formed by two arms, in contact with which the tongue comes to be placed. The first arm is relatively long and is placed under the tongue during use, which holds the tongue in a high position in order to remedy infantile deglutition. However, this average technique forces the tongue to be positioned correctly, reducing the desire of the child for the comforter owing to the discomfort caused. Moreover, the tongue cannot keep its position of rest.

### TECHNICAL PROBLEM AND SOLUTION

The devices of the prior art are not satisfactory for preventing all the drawbacks related to the use of traditional comforters. Consequently one of the main aims of the invention is to propose a novel comforter avoiding the drawbacks related to the use of current devices, in particular avoiding dento-maxillary distortions related firstly to breathing through the mouth and secondly to maintaining infantile deglutition.

The invention therefore proposes a novel comforter intended for children in temporary or permanent dentition, whose central and lateral incisors have achieved their eruption, comprising in particular an intra-oral part promoting the guidance of the mandibular movements and a physiological placement of rest of the mandible. This intra-oral part comprises two frontal grooves separated by an inclined plane, or any alternative means allowing the natural position of the dental arches. Preferably, the intra-oral part has a reduced retro-incisor volume, which enables the tongue to keep its position of rest without being pushed towards the rear.

In a preferred embodiment, the comforter of the invention advantageously has a lingual guidance device, or lingual bulb, promoting the high and front positioning of the tongue.

### BRIEF DESCRIPTION

Thus the subject matter of the invention is a comforter made from rigid or semi-rigid plastic material, intended for children with temporary or permanent dentition, whose upper and lower central and lateral incisors have achieved their eruption, and characterised in that it comprises three parts secured together:
a labial screen, perforated or not, or screen (B),
a means (A) for gripping or closing the screen (B),
an intra-oral part (C), consisting of a frame made from rigid plastic material,

the intra-oral part (C) and the means (A) being secured to the screen (B), and situated on either side thereof,

characterised in that said intra-oral part (C) comprises at least one lower incisor groove (2) in the shape of hook, comprising an inclined bite plane (6), the hollow of the groove and a retro-incisor return, said retro-incisor return of the groove (2) having a thickness from 0.5 to 7 mm, preferably from 1 to 4 mm, more preferably from 1.5 to 2 mm, which enables the tongue to keep its position of rest without its being pushed towards the rear.

According to a particular embodiment, the intra-oral part (C) is characterised in that it comprises:
two opposite labial grooves (4) and (5),
two opposite incisor grooves (1) and (2) separated by an inclined bite plane (6),

said labial grooves (4) and (5) being situated immediately after the labial screen (B), opposite each other on a vertical plane, and

said incisor grooves (1) and (2) being situated immediately after the labial grooves (4) and (5).

The shape of the grooves is such that it enables the guidance of the mandibular movements and a stable placing of the lower dental arch with respect to the upper one, a placing that corresponds to the natural positioning of rest of the mandible.

The three parts (A), (B) and (C) can form only one, or two or three pieces.

Preferably said children with temporary or permanent dentition, whose upper and lower central and lateral incisors have achieved their eruption, are children from 12 months to 8 years. Particularly aimed at are children from 12 months to 8 years having cranial facial deformation and/or malfunctions of respiration and deglutition.

### DESCRIPTION OF THE FIGURES

FIG. 1 presents a perspective view of the comforter according to the invention.

FIG. 2 presents a view in median section of the comforter according to the invention, in the case where the labial grooves are strongly marked.

FIG. 3 presents a median section of the comforter according to the invention, in the case where the labial grooves are strongly marked, in situ in the mouth of a child.

FIG. 4 presents a lateral view of the comforter according to the invention in the case where the labial grooves are not very pronounced.

FIG. 5 presents a median section of the comforter according to the invention in the case where the labial grooves are not very pronounced, in situ in the mouth of a child.

### DETAILED DESCRIPTION

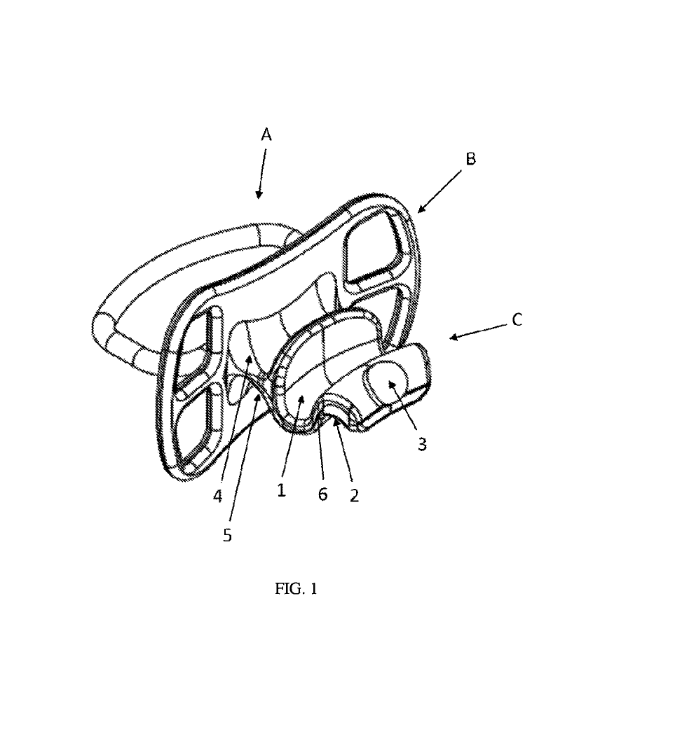

The comforter according to the invention, shown in FIG. 1, consists of an intra-oral part (C), connected to a means (A) by a screen (B), these parts being as described previously.

The comforter according to the invention, through the particular shape of its intra-oral part (C), can be placed in the mouth only in a specific orientation, as shown in FIGS. 3 and 5.

Advantageously, the comforter according to the invention has no sharp corner, but on the contrary has non-traumatic rounded corners, in order to avoid any injury to the mucosae of the child.

According to one embodiment of the invention, the means (A) is a gripping means consisting of a ring as shown in FIGS. 1, 2 and 4. According to another embodiment of the invention, the means (A) is a device for closing the screen (B), which may be in the shape of a knob, as shown in FIGS. 3 and 5.

Advantageously, the labial screen (B) is perforated and of sufficient size so as to eliminate any risk of ingestion of the comforter by the child and suffocation.

The intra-oral part (C) comprises means for ensuring natural positioning, in the anteroposterior plane and in the vertical plane of the lower dental arch (13) with respect to the upper dental arch (12).

Within the meaning of the present invention, the “natural positioning”, in the absence of pathology, is such that the mandible (13) has an essentially posterior and inferior position with respect to the maxilla (12), the mandibular incisors (10) being in posterior position with respect to the upper incisors (9), either in contact during incision and deglutition, or separated from 1.5 to 2 mm in a physiological position of rest.

The dimensions of the comforter of the invention, in particular of the intra-oral part (C), depend on the dimensions of the upper and lower incisors, which are:

| | | Meso-distal | Vestibulo-lingual |
|---|---|---|---|
| Incisors | Height of crown | crown diameter | diameter |
| Upper central | 6 mm | 6.5 mm | 5 mm |
| Upper lateral | 5.6 mm | 5 mm | 4.8 mm |
| Lower | 5 mm | 4 mm | 4 mm |

“Crown height” means the height of the external part of the tooth, “meso-distal crown diameter” means its width and “vestibulo-lingual diameter”, means its thickness.

### Labial Grooves (4) and (5)

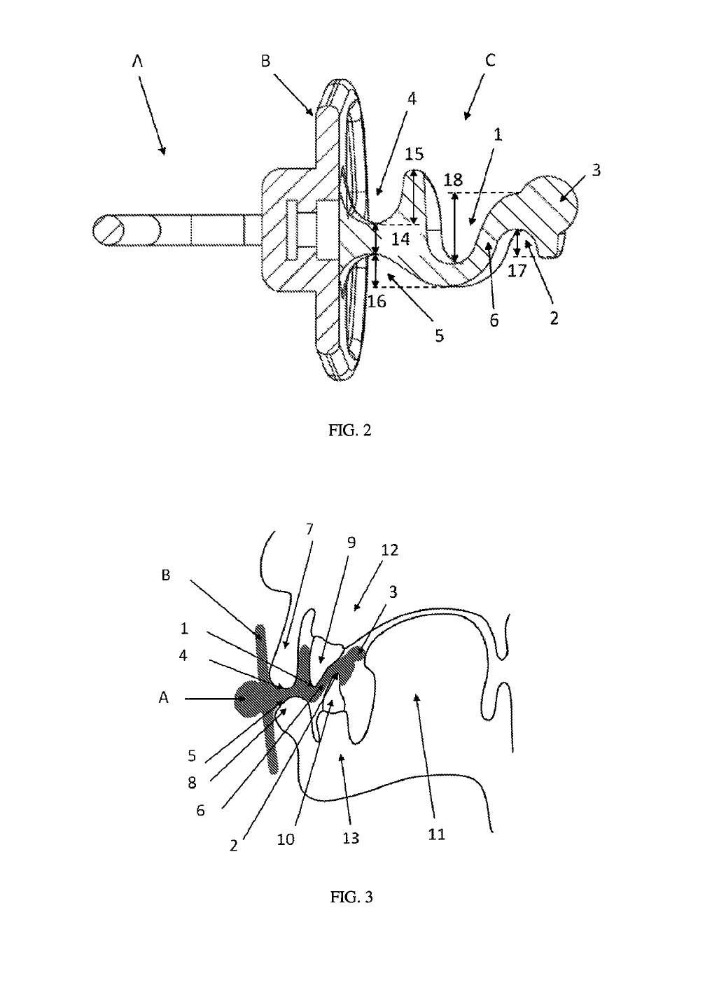

The intra-oral part (C), shown in FIG. 2, comprises two labial grooves (4) and (5), situated immediately after the labial screen (B), opposite each other in a vertical plane. The grooves (4) and (5) are intended to accept respectively the upper lip (7) and the lower lip (8), as shown in FIG. 3.

According to one embodiment of the invention, the labial grooves (4) and (5) are separated by a thickness (14) from 1 to 6 mm, preferably from 1.5 to 3 mm and more preferably from 2 to 2.5 mm.

According to one embodiment of the invention, the length of the labial grooves (4) and (5) is from 15 to 25 mm, preferably from 18 to 22 mm.

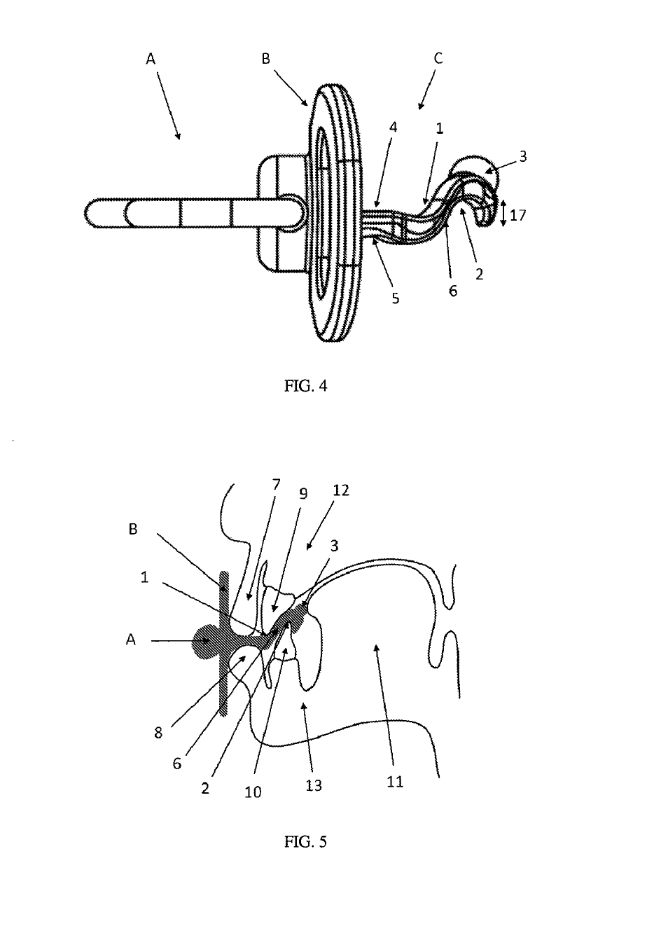

According to one embodiment of the invention, the return (15) of the labial groove (4) has a height from 0 to 15 mm. According to a particular embodiment, the return (15) has a height from 6 to 15 mm, preferably from 8 to 10 mm, as shown in FIGS. 1 and 2. According to another embodiment, the return (15) has a height from 0 to 3 mm, preferably from 0.5 to 1.5 mm, as shown in FIG. 4.

According to one embodiment of the invention, the depth (16) of the labial groove (5) is from 0 to 15 mm. According to a particular embodiment, the depth (16) is from 5 to 10 mm, as shown in FIGS. 1 and 2. According to another particular embodiment, the depth (16) is from 0 to 3 mm, as shown in FIG. 4.

The labial grooves (4) and 5) have radii of curvature adapted to the morphology of the lips and dental arches.

Within the meaning of the present invention, the “radius of curvature in the vertical plane”, that is to say in the vertical midplane perpendicular to the plane formed by the labial screen, corresponds to the radius of the circle tangent to the bottom of the groove.

Within the meaning of the present invention, the “radius of curvature in the horizontal plane”, that is to say in a horizontal plane perpendicular to the plane formed by the labial screen, makes it possible to take account of the arched character of the grooves that follow the shape of the dental arch. This radius corresponds to the radius of the circle tangent to the groove in the direction of the length.

The radii of curvature can be determined by means of computed aided design software such as Solidworks-2011.

According to one embodiment of the invention, the radius of curvature in the vertical plane of the upper labial groove (4) is from 2 to 5 mm, preferably 3 mm.

According to one embodiment of the invention, the radius of curvature in the horizontal plane of the upper labial groove (4) is from 25 to 35 mm, preferably 30 mm.

According to one embodiment of the invention, the radius of curvature in the vertical plane of the lower labial groove (5) is from 2.5 to 5.5 mm, preferably from 3 to 3.5 mm.

According to one embodiment of the invention, the radius of curvature in the horizontal plane of the lower labial groove (5) is from 25 to 35 mm, preferably 30 mm.

### Incisor Grooves (1) and (2)

Behind the labial grooves (4) and (5) there are two other front grooves (1) and (2), referred to as incisor grooves, opposite each other. As shown in FIG. 3, the groove (1) is intended to receive the central and lateral maxillary incisors (9) and the grooves (2), the central and lateral mandibular incisors (10). The groove (1) makes it possible in particular to lock the upper incisors and the groove (2) makes it possible to have laxity of movement of the mandible (13).

The shape of the incisor grooves (1) and (2) is designed to prevent any injury to the gum tissues.

The incisor grooves (1) and (2), associated with the labial grooves (4) and (5), ensure the stability in the mouth of the comforter of the invention through the action of the lips and incisors.

According to one embodiment of the invention, the depth (18) of the upper incisor groove (1) is sufficient to receive the crown of the upper incisors, and the depth (17) of the lower incisor groove (2) can accept half the crown height of the lower incisors.

According to one embodiment of the invention, the depth (18) of the incisor groove (1) is from 2 to 15 mm, preferably from 4 to 10 mm. According to another embodiment of the invention, the depth (18) of the incisor groove (1) is from 0 to 3 mm.

According to one embodiment of the invention, the depth (17) of the incisor groove (2) is from 1 to 10 mm, preferably from 1 to 6 mm, more preferably from 2.5 to 3.5 mm.

The length of the grooves (1) and (2) is slightly less than the sum of the widths of the upper central and lateral incisors, the sum of the meso-distal diameters of the upper incisors being approximately 23 mm.

According to one embodiment of the invention, the length of the grooves (1) and (2) is from 15 to 24 mm, preferably from 18 to 22 mm.

The incisor grooves (1) and (2) have radii of curvature adapted to the morphology of the dental arches and the width of the teeth.

According to one embodiment of the invention, the radius of curvature in the vertical plane of the upper incisor groove (1) is from 1.5 to 5 mm, preferably from 2.2 to 3 and more preferably 2.4 mm.

According to one embodiment of the invention, the radius of curvature in the horizontal plane of the upper incisor groove (1) is from 25 to 35 mm, preferentially 30 mm.

According to one embodiment of the invention, the radius of curvature in the vertical plane of the lower incisor groove (2) is from 1 to 4 mm, preferentially 2 mm.

According to one embodiment of the invention, the radius of curvature in the horizontal plane of the lower incisor groove (2) is from 25 to 35 mm, preferentially 30 mm.

According to one embodiment, the radii of curvature of the incisor grooves (1) and (2) may be different, with preferentially a radius of curvature in the horizontal plane that is greater for the lower incisor groove (2).

### Inclined Bite Plane (6)

The grooves (1) and (2) are separated by an inclined bite plane (6).

According to one embodiment, the angle of inclination of the plane (6) with respect to the horizontal is from 50° to 80°, preferably from 60° to 70°. This angle of inclination is such that, when the teeth are placed in the grooves (1) and (2), their position corresponds to a natural position and to the physiological position of rest of the lower jaw (13). The inclination of the bite plane (6) allows in particular a sliding of the lower incisors (10), either upwards and forwards, a so-called propulsion movement, or upwards and rearwards, an incision movement, which makes it possible to obtain an anterior incisor guidance close to natural guidance. When the child clamps its teeth on the comforter of the invention, its lower incisors (10) will slide along the inclined bite plane (6) in order to arrive in the lower incisor groove (2), this interlocking of the incisors in the incisor grooves promoting the stability of the comforter in the mouth of the child, and affording the necessary stability during deglutition.

According to one embodiment of the invention, the inclined bite plane (6) has a thickness of from 1 to 2 mm, this limited thickness being essential for preventing the appearance of a wide incisor gap. The thickness of the inclined plane (6) is chosen so as to be close to the free incisor inocclusion space, which is typically around 2 mm. The thin inclined plane of the comforter according to the invention makes it possible for its insertion not to interfere with the free rest space, and does not interfere with the lingual posture.

According to one embodiment, the shape of the inclined bite plane (6), as well as the depth of the incisor grooves (1) and (2), are adapted to the mouth of children suffering from advanced deformations, such as a large incisor gap, in order to facilitate the holding of the comforter, to prevent the interposition of the tongue between the incisors and to facilitate lingual re-education.

### Retro-Incisor Return and Lingual Bulb (3)

According to one embodiment of the invention, the retro-incisor return of the groove (2) has reduced thickness, from 1.5 to 2 mm. The fact that this retro-incisor volume is very small avoids pushing the tongue (11) towards the rear and enables it to keep its position of rest.

According to one embodiment, the comforter of the invention has a lingual bulb (3) centred on the upper part of the retro-incisor return of the groove (2). Advantageously, the lingual bulb (3) spontaneously draws the tip of tongue upwards and forwards and thus assists deglutition of the adult type.

According to one embodiment, the lingual bulb (3) will be in the shape of a hemisphere with a diameter from 4 to 6 mm.

### Materials

According to one embodiment, the comforter according to the invention is formed from a rigid plastic material of the polycarbonate type, having a hardness from 50 to 100 Shore D, preferably from 60 to 90 Shore D and more preferentially 80 Shore D, and may be covered with an elastomer thermoplastic polymer of the SEBS (Styrene Ethylene Butadiene Styrene) type.

The rigidity of the device limits the effect of the lingual pressure on the incisors and its harmful effects, which prevents or limits the vestibular version of the teeth.

According to one embodiment of the invention, the intra-oral part (C) is produced from rigid or semi-rigid plastic material, of the polycarbonate type with a hardness from 50 to 100 Shore D, preferably from 60 to 90 Shore D and more preferentially 80 Shore D, and may be covered in whole or in part with a flexible material of the silicone type or thermoplastic polymer of the SEBS type.

According to one embodiment of the invention, the lingual bulb (3) is formed from a plastic material more flexible than that constituting the intra-oral part (C), such as for example SEBS elastomers, in order to make its contact with the tongue more pleasant.

According to one embodiment of the invention, a band of flexible material, of the SEBS type, covers the bottom of the incisor grooves (1) and (2), in order to improve the contact sensation and stimulate incision movements. For industrial reasons and reasons of strength, said band of flexible material and the lingual bulb (3) may form a single piece, set in the frame of the intra-oral part (C), obtained for example by injection of SEBS in the rigid frame.

### Personalised Comforter

Another subject matter of the invention is a personalised comforter. This is because, according to one embodiment of the invention, the comforter may be personalised in accordance with the following method: a thermoplastic polymer, for example caprolactam or similar, is put in place after having been heated at the two incisor grooves (1) and (2), preferentially on the upper incisor groove (1), and then adapted specifically to the incisors of the child. According to this embodiment, the comforter of the invention provided with heated thermoplastic polymer is placed in the mouth of the child and then removed, on several occasions, in order to take the impression of its incisors. The excess polymer is then removed with a chisel or scalpel so as not to cause irritation of the mucosae. In this embodiment, said polymer constitutes a “damper” layer and assists the retention of the comforter. According to a particular embodiment, for children whose dental arrangement is correct, the impression of their teeth is taken using a thermoplastic polymer in the upper and lower grooves (1) and (2). According to another particular embodiment, for children whose dentition is not completely regular and harmonious, only the impression of the upper teeth is taken with said polymer in the upper groove (1). According to another particular embodiment, for children whose dentition is irregular, no impression is taken with said polymer in the grooves (1) and (2).

The personalised comforter of the invention is therefore characterised in that it comprises the structural elements of the comforter of the invention as well as a thermoplastic polymer in the incisor groove (1) and/or in the incisor groove (2), said polymer having the impression of the incisors of the child for whom said personalised comforter is intended, said impressions having been obtained in the following manner:
spreading of heated thermoplastic polymer in the grooves (1) and/or (2) of the comforter,
placing of the comforter in the mouth of the child,
removal and replacing of the comforter on the incisors of the child during the hardening of the thermoplastic polymer.
cleaning of the excess polymer.

### Orthodontic Advantages

Respiration through the mouth requires a minimum mouth opening, that is to say a low position of the mandible, with the mouth open and the lips separated, in order to leave clear the mouth air passage. This minimal opening does not enable the comforter of the invention to be held in the mouth of the child. On the contrary, the comforter of the invention requires the child to keep a limited opening (mouth closed, lips in contact, natural position) and limits respiration through the mouth by obstructing, through its form, the mouth air passage. The comforter of the invention therefore imposes nasal respiration on the child, the only one suitable for promoting harmonious development of the cranio-facial body.

Moreover, the comforter of the invention acts as a maxillary anterior stop or Lucia JIG. Wearing it for a few minutes, when it is held without pressure and is interposed as a simple stop in the inocclusion space and on the closure path, deprograms the adaptation reflexes used by the central nervous system and makes it possible to obtain symmetrical decontraction of the masticator muscles, leading to better relaxation of the child.

In addition the comforter of the invention can advantageously be used as a re-education device for children suffering from atypical deglutition. This is because, firstly, the bite plane prevents the interposing of the tongue between the lower and upper incisors, the lingual stimulator fulfilling a role of functional guide in order to bring the tip of the tongue to bear on the retro-incisor papilla. The device can be used as a supplement to lingual re-education treatments established by speech therapists or physiotherapists.

### Definitions

“Temporo-mandibular articulations” means the articulations, one right and one left, connecting the lower jaw and the cranium.

“Deglutition” means the action by which the saliva or any other liquid or the alimentary bolus is swallowed.

“Infantile deglutition” means the normal deglutition of the newborn baby, normal up to 3-4 years.

“Atypical deglutition” means infantile deglutition persisting after the age of 3-4 years.

“Adult deglutition” means the normal deglutition of a child after 4 years and of adults.

“Labial screen” means a structure intended to reduce the risk of aspiration of the entire comforter into the mouth of the child.

“Free inocclusion space” means a space separating the upper and lower teeth apart from mastication and deglutition phenomena, resulting from equilibrium between the phenomenon of weightlessness and the contraction of the mandible lifting muscles, and meaning that the teeth never touch at rest. This space varies from 1 to 2.5 mm.

“Lingual face” means, for the lower incisors, the internal face, in contact with the tongue.

“Palatine face” means, for the upper incisors, the internal face, on the mouth side.

“Vestibular face” means, for the incisors, the external face in contact with the lips.

“Anterior guidance” means the guidance of the mandibular movements obtained by the contact of the lower incisors on the palatine face of the upper incisors. This anterior guidance is established gradually at the time of eruption of the lacteal teeth. During the first year of life, the functional mandibular movements are movements with a horizontal main component.

“Incision” means the movement of the mandible to the rear and upwards with contact of the free edge of the lower incisors against the palatine face of the upper incisors, enabling the food to be cut before mastication thereof by the premolar-molar groups.

“Lucia JIG (Joint Incisal Guidance)” means the principle of action of the Lucia interocclusal device, which is to eliminate all the proprioceptive afferences of the premolar and molar sectors by offering only incisor contact, and thus to obtain decontraction of the masticator muscles.

“Mandible” means the lower jaw.

“Maxilla” means the upper jaw.

“Occlusion” means the relationship, with the teeth clamped, between the upper and lower jaws, dependent on the position of the teeth and the inter-dental relationships. Dental occlusion is the way in which the lower teeth mesh with the upper teeth.

“Condylar slope” means the slope formed by the temporal condyle, that is to say the articular surface of the condyle, on which the mandibular condyle slides, this slope being determined by the anterior function and guidance.

“Comforter” means an article used to satisfy the non-nutritional suction requirements of children and to calm them.

“Retro-incisor space” means the space of the intra-oral part (C) of the comforter situated behind the lower incisors.

The invention will be understood better from a reading of the following example, which illustrates non-limitatively the comforter according to the invention.

### EXAMPLE

Study of Deglutition when the Comforter of the Invention is Present

In order to show the advantage of the present comforter, a study on deglutition was carried out in order to compare deglutition when the comforter of the invention is present with deglutition when a traditional comforter is present, infantile deglutition and adult deglutition.

Table 1 summarises the movements of the mandible, the position of the tongue, the bearing points and the inter-arch relationships obtained in the various situations of deglutitions studied.

Comparison of the various parameters studied for deglutition shows that the comforter according to the invention makes it possible to obtain deglutition close to adult deglutition contrary to what is obtained with a traditional comforter.

TABLE 1

| Deglutition | Mandible movement | Tongue position | Bearing point | Inter-arch relationship |
|---|---|---|---|---|
| Adult | Oblique, upwards and to the rear | At the top and forwards | Retro-incisor papilla, | Teeth clamped with a |
| | according to the anterior | | palatine face of the upper | maximum contact, stability |
| | guidance | | incisors | by dental wedging |
| Infantile or | Vertical, upwards | Middle and forwards | Inter-incisor | Moderate stability due to the |
| atypical | | | | interposition of the tongue |
| | | | | between the arches |
| Traditional | Small amplitude, vertical, | At the bottom and to the | Intra-oral part (teat) of | Teeth separated by more |
| comforter | upwards | rear (because of the large | the comforter | than 5 mm, absence of |
| | | intra-oral volume | | wedging |
| Comforter of | Oblique upwards and to the rear, | At the top and in front | Lingual bulb (3), at 2-3 mm | Incisors in contact with |
| the invention | amplitudes slightly less than | | from the retro- | grooves (1) and (2), |
| | adult deglutition | | incisor papilla | separated by 1.5-2 mm, |
| | | | | stability by wedging of the |
| | | | | teeth in the comforter |

1.-11. (canceled)

12. A comforter comprising three parts attached together:
a labial screen, perforated or not;
a grip or closure for the labial screen for gripping or closing the labial screen; and
an intra-oral part;
wherein:
the intra-oral part and the grip or closure are secured to the labial screen, and situated on either side thereof; and
the intra-oral part comprises at least one lower incisor groove in the shape of hook comprising an inclined bite plane, the hollow of the groove and a retro-incisor return, the retro-incisor return of the groove having a thickness from 1 to 4 mm which enables the tongue to keep its position of rest without being pushed towards the rear during use.

13. The comforter of claim 12, wherein the intra-oral part comprises a lingual bulb centered on the upper part of the retro-incisor return of the groove, promoting upward and forward positioning of the tongue during use.

14. The comforter of claim 12, wherein the intra-oral part comprises:
two opposite labial grooves; and
first and second incisor grooves separated by an inclined bite plane;
wherein the labial grooves are situated immediately after the labial screen, opposite each other on a vertical plane, and the incisor grooves are situated immediately after the labial grooves.

15. The comforter of claim 14, wherein the labial grooves are separated by a thickness from 1 to 6 mm.

16. The comforter of claim 14, wherein the depth of the first incisor groove is from 2 to 15 mm, and the depth of the second incisor groove is from 1 to 10 mm.

17. The comforter of claim 14, wherein the depth of the first incisor groove is from 0 to 3 mm.

18. The comforter of claim 14, wherein the incisor grooves have lengths from 15 to 24 mm.

19. The comforter of claim 12, wherein the inclined bite plane has an angle of inclination with respect to the horizontal from 50° to 80°, and has a thickness from 1 to 2 mm.

20. The comforter of claim 12, wherein the intra-oral part is made from rigid plastic material of the polycarbonate type with a hardness from 50 to 100 Shore D.

21. The comforter of claim 20, wherein the intra-oral part is covered in whole or in part by a flexible material of the silicone type or thermoplastic polymer of the SEBS type.

22. The comforter of claim 12, wherein the comforter is adapted for use by children with temporary or permanent dentition, whose central and lateral incisors have erupted.

23. The comforter of claim 22, wherein the comforter is adapted for use by children of from 12 months to 8 years having cranio-facial deformations and/or malfunctions of respiration and deglutition.

24. A personalized comforter of claim 12, comprising a thermoplastic polymer placed in an at least one incisor groove, the polymer having an impression of at least one incisor of a child for whom the personalized comforter is intended, wherein the impression is obtainable by a method comprising:
spreading of heated thermoplastic polymer in the incisor groove;
placing of the comforter in the mouth of the child;
placing the comforter on the incisors of the child during the hardening of the thermoplastic polymer; and
cleaning off any excess polymer.

25. A comforter comprising three parts attached together:
a labial screen, perforated or not;
a grip or closure for the labial screen for gripping or closing the labial screen; and
an intra-oral part;
the intra-oral part and the grip or closure are secured to the labial screen, and situated on either side thereof;
wherein:
the intra-oral part comprises:
two opposite labial grooves;
two opposite incisor grooves: a lower incisor groove and an upper incisor groove, separated by an inclined bite plane;
the labial grooves situated immediately after the labial screen, opposite each other on a vertical plane;
the incisor grooves situated immediately after the labial grooves;
the lower incisor grooves are in the shape of hook and comprising a retro-incisor return; and
the retro-incisor return comprises a lingual bulb centered on an upper part of the retro-incisor return of the groove, promoting upward and forward positioning of the tongue during use.

26. The comforter of claim 25, wherein the comforter is adapted for use by children with temporary or permanent dentition, whose central and lateral incisors have erupted.

27. The comforter of claim 26, wherein the comforter is adapted for use by children of from 12 months to 8 years having cranio-facial deformations and/or malfunctions of respiration and deglutition.
